(19) United States
(12) Patent Application Publication
(10) Pub. No.: US 2026/0082318 A1
(43) Pub. Date: Mar. 19, 2026

(54) SELECTING USER PLANE FUNCTION BASED ON INTERNET PROTOCOL STACK CAPABILITIES

(71) Applicant: T-MOBILE INNOVATIONS LLC, Overland Parks, KS (US)

(72) Inventors: Rahul Rashmikant AMIN, Issaquah, WA (US); Saravana Kumar Velusamy, Overland Park, KS (US); Tingchun Kang, Redmond, WA (US); Narayanan Govindan Kasi, Olathe, KS (US)

(21) Appl. No.: 18/885,495

(22) Filed: Sep. 13, 2024

(51) Int. Cl. H04W 48/18; H04L 61/5007; H04L 101/686; H04W 8/22; H04W 76/10

(52) U.S. Cl. CPC H04W 48/18; H04L 61/5007; H04W 8/22; H04W 76/10; H04L 2101/686

(57) ABSTRACT

The present disclosure is directed to systems and methods for selecting a user plane function (UPF) from among a plurality of available UPFs at least partially based on an internet protocol version of the UPF matching an IP version capability of a base station. A base station will communicate its IP version capability to a mobility network function (e.g., an access mobility function (AMF)) so that session establishment requests forwarded to a session management network function or gateway (e.g., a session management function (SMF)) can include the base station's IP version capability—allowing it to be used by the session management network function for selecting a UPF.

### SUMMARY

The present disclosure is directed, in part, to selecting a user plane function based on an internet protocol stack capability of a radio access network node, substantially as shown and/or described in connection with at least one of the figures, and as set forth more completely in the claims.

According to various aspects of the technology, a user plane function (UPF) is selected at least partially based on its internet protocol (IP) version capability matching the IP version capability of a particular base station. The base station communicates its IP version capability to a mobility network function, which in turn communicates it to a session management network function or gateway for the purpose of selecting a UPF with the same IP version capabilities. Conventionally, IP version compatibility of the base station serving the UE is not considered during UPF selection; if there is a mismatch, it can cause a fault that results in a protocol data unit (PDU) session establishment failure. By selecting a UPF at least partially based on the UPF's IP version capability matching the base station's IP version capability, mismatch-based failures that increase latency and expend additional computing resources can be reduced or eliminated.

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

### BRIEF DESCRIPTION OF THE DRAWINGS

FIG. 1 illustrates a computing device for use with the present disclosure;

FIG. 2 illustrates a diagram of a network environment in which implementations of the present disclosure may be employed;

FIG. 3 illustrates a call flow diagram of a method for selecting a user plane function based on internet protocol version capability for use with the present disclosure;

FIG. 4 illustrates a flow diagram of a method for establishing a session with a user plane function for use with the present disclosure; and,

FIG. 5 illustrates a flow diagram of a method for reporting internet protocol version capabilities of a base station for use with the present disclosure.

### DETAILED DESCRIPTION

The subject matter of embodiments of the invention is described with specificity herein to meet statutory requirements. However, the description itself is not intended to limit the scope of this patent. Rather, the inventors have contemplated that the claimed subject matter might be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Various technical terms, acronyms, and shorthand notations are employed to describe, refer to, and/or aid the understanding of certain concepts pertaining to the present disclosure. Unless otherwise noted, said terms should be understood in the manner they would be used by one with ordinary skill in the telecommunication arts. An illustrative resource that defines these terms can be found in Newton's Telecom Dictionary, (e.g., 32d Edition, 2022). As used herein, the term “base station” refers to a centralized component or system of components that is configured to wirelessly communicate (receive and/or transmit signals) with a plurality of stations (i.e., wireless communication devices, also referred to herein as user equipment (UE(s))) in a particular geographic area. As used herein, the term “network access technology (NAT)” is synonymous with wireless communication protocol and is an umbrella term used to refer to the particular technological standard/protocol that governs the communication between a UE and a base station; examples of network access technologies include 3G, 4G, 5G, 6G, 802.11x, and the like.

Embodiments of the technology described herein may be embodied as, among other things, a method, system, or computer-program product. Accordingly, the embodiments may take the form of a hardware embodiment, or an embodiment combining software and hardware. An embodiment takes the form of a computer-program product that includes computer-useable instructions embodied on one or more computer-readable media that may cause one or more computer processing components to perform particular operations or functions.

Computer-readable media include both volatile and nonvolatile media, removable and nonremovable media, and contemplate media readable by a database, a switch, and various other network devices. Network switches, routers, and related components are conventional in nature, as are means of communicating with the same. By way of example, and not limitation, computer-readable media comprise computer-storage media and communications media.

Computer-storage media, or machine-readable media, include media implemented in any method or technology for storing information. Examples of stored information include computer-useable instructions, data structures, program modules, and other data representations. Computer-storage media include, but are not limited to RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These memory components can store data momentarily, temporarily, or permanently.

Communications media typically store computer-useable instructions - including data structures and program modules - in a modulated data signal. The term “modulated data signal” refers to a propagated signal that has one or more of its characteristics set or changed to encode information in the signal. Communications media include any information-delivery media. By way of example but not limitation, communications media include wired media, such as a wired network or direct-wired connection, and wireless media such as acoustic, infrared, radio, microwave, spread-spectrum, and other wireless media technologies. Combinations of the above are included within the scope of computer-readable media.

By way of background, the establishment of a protocol data unit (PDU) session in a 5G network is a multi-step process that involves the interaction between the User Equipment (UE), the base station (e.g., gNodeB), a mobility network function (e.g., an Access and Mobility Management Function (AMF)), a session management network function or gateway (e.g., a Session Management Function (SMF)), and the User Plane Function (UPF). In 5G, for example, when the UE initiates a request to establish a PDU session, it first communicates with the gNodeB, which forwards the request to the AMF. The AMF, acting as a control plane entity, relays the session request to the SMF, which is responsible for session management. The SMF then selects an appropriate UPF based on factors such as the UE's location, network policies, and available resources. The UPF, which manages user data traffic, assigns an IP address to the UE, which will be used for the duration of the session. This IP address allows the UE to communicate with external data networks, facilitating the flow of user data between the UE and the data network. The SMF configures the necessary data paths within the UPF, ensuring that the data packets are correctly routed to and from the UE. Once the session is established, the UPF handles the actual forwarding of user data, enforcing Quality of Service (QoS) policies and supporting data packet routing, while the SMF and AMF maintain the session's control plane states and facilitate mobility management.

Conventionally, a session management network function or gateway selects a UPF based on geographical proximity of the UPF to the UE, data network connectivity between a candidate UPF and the data network targeted by the UE, and load balancing. IP version compatibility of the base station serving the UE is not conventionally considered during UPF selection; that is, the IP version capabilities of the base station may not match the IP version capabilities of the UPF selected by the session management network function. For example, when a base station supports IPv4 only (i.e., not dual stack), but is assigned an IP address of a different version (e.g., receives a dual stack or IPv6 only assignment), it typically causes a fault that results in a PDU session establishment failure. That failure leads to a re-attempt by the network to establish a PDU session, expending computing resources and creating latency for the UE.

In contrast to conventional solutions, the present disclosure is directed to selecting a UPF at least partially based on its IP version capability matching the IP version capability of a particular base station. In order to select a UPF based at least partially on its IP version capability, a base station will report its IP version capability to a mobility network function periodically or during setup messaging. Once the mobility network function receives a session establishment request for a UE attached to that base station, the mobility network function includes the IP version capability of the base station to the session management network function or gateway in order that it may select a UPF having the same IP version capability as the base station. This ensures that the subsequent IP address assignment from the UPF matches the capabilities of the base station, preventing a transport layer mismatch, and ensuring that the session establishment does not fail.

Accordingly, a first aspect of the present disclosure is directed to a system for selecting a user plane function (UPF) based on internet protocol (IP) version capability. The system comprises one or more computer processing components configured to execute operations comprising receiving a session establishment request message from a mobility network function (NF), wherein the request message is associated with a session between a radio access network (RAN) node and a UE, the request message comprising one or more information elements that indicate the RAN node has a first internet protocol stack capability. The operations further comprise selecting a first user plane function (UPF) from a plurality of available UPFs at least partially based on the first UPF having the first internet protocol stack capability.

Another aspect of the present disclosure is directed to a method for selecting a user plane function (UPF) based on internet protocol (IP) version capabilities. The method comprises receiving a session establishment request message from a mobility network function (NF), wherein the request message is associated with a session between a radio access network (RAN) node and a user equipment (UE), the request message comprising one or more information elements that indicate the RAN node has a first internet protocol version. The method further comprises selecting a first user plane function (UPF) from a plurality of available UPFs at least partially based on the first UPF having the first IP version capability.

Another aspects of the present disclosure is directed to a method for selecting a core network function based on internet protocol (IP) version capabilities of a base station. The method comprises communicating a message from the base station to a mobility network function of a telecommunication network, the message comprising an IP version capability of the base station. The method further comprises receiving a session establishment request from a user equipment (UE). The method further comprises communicating the session establishment request to the mobility network function. The method further comprises receiving an IP address assignment for the UE from the mobility network function, the IP address assignment having an IP version being the same as the IP version capability of the base station.

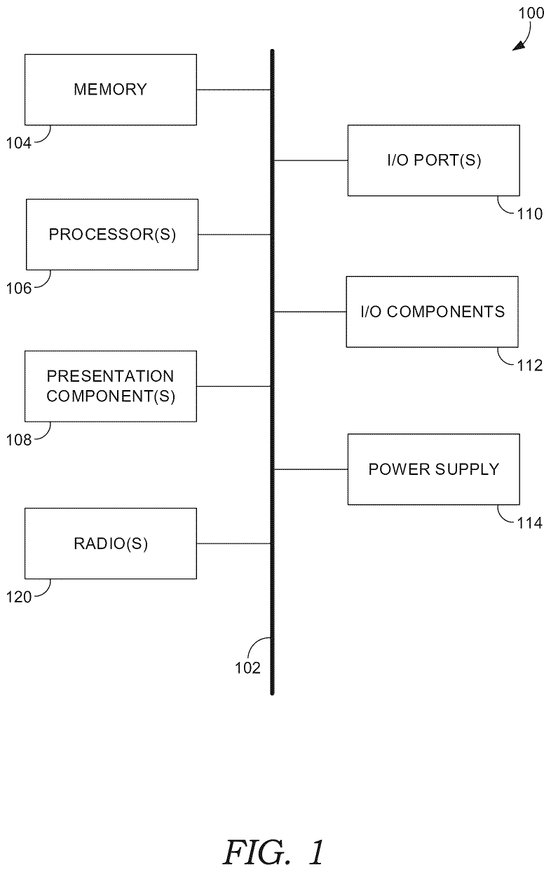

Referring to FIG. 1, an exemplary computer environment is shown and designated generally as computing device 100 that is suitable for use in implementations of the present disclosure. Computing device 100 is but one example of a suitable computing environment and is not intended to suggest any limitation as to the scope of use or functionality of the invention. Neither should computing device 100 be interpreted as having any dependency or requirement relating to any one or combination of components illustrated. In aspects, the computing device 100 is generally defined by its capability to transmit one or more signals to an access point and receive one or more signals from the access point (or some other access point); the computing device 100 may be referred to herein as a user equipment, wireless communication device, or user device. The computing device 100 may take the form of a wireless access device that acts as a more localized and consolidated access point that provides end user wireless devices access to a broader network; examples of wireless access devices include fixed wireless access (FWA) devices and mobile hotspots. The computing device 100 may take the form of a mobile device, used herein to refer to categories of often-portable devices that utilize a wireless connection to a broader network and are typically configured for direct human interaction and personal computing tasks; examples of mobile devices include smartphones, tablets, computers (e.g., laptops and PCs), wearable devices (e.g., smartwatches, fitness tracker), electronic readers (i.e., an e-book reader or digital book reader), portable media player, handheld GPS/location device, digital camera, gaming console, and digital voice recorders. The computing device may take the form of a connected vehicle that integrates advanced communication and computing technologies to interact with other devices and networks, encompassing vehicle to vehicle (V2V) communications, vehicle to infrastructure (V2I) communications, and/or vehicle to everything (V2X) communications, and that utilizes a wireless connection to support telematics, infotainment systems, over the air updates, vehicle health monitoring, and/or enhanced navigation; examples of connected vehicles include automotive, locomotive, airborne, and cargo (e.g., train car, semi-trailer) systems. The computing device 100 may take the form of an Internet of Things (IoT) device, a physical object embedded with sensors, software, or other technologies that enable them to collect, exchange, and act on data using an internet connection, which allows them to perform automated, decision-making or, other content-provision tasks; examples of IoT devices include smart home devices (e.g., smart thermostats, smart lights, power supply/management systems, and smart security systems), connected appliances (e.g., smart refrigerators), health monitoring devices (e.g., blood pressure monitor, glucose monitor), industrial devices (e.g., smart sensors, predictive maintenance systems), and agricultural devices (e.g., soil, environmental, or growth sensors).

The implementations of the present disclosure may be described in the general context of computer code or machine-useable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. Implementations of the present disclosure may be practiced in a variety of system configurations, including handheld devices, consumer electronics, general-purpose computers, specialty computing devices, etc. Implementations of the present disclosure may also be practiced in distributed computing environments where tasks are performed by remote-processing devices that are linked through a communications network.

With continued reference to FIG. 1, computing device 100 includes bus 102 that directly or indirectly couples the following devices: memory 104, one or more processors 106, one or more presentation components 108, input/output (I/O) ports 110, I/O components 112, and power supply 114. Bus 102 represents what may be one or more busses (such as an address bus, data bus, or combination thereof). Although the devices of FIG. 1 are shown with lines for the sake of clarity, in reality, delineating various components is not so clear, and metaphorically, the lines would more accurately be grey and fuzzy. For example, one may consider a presentation component such as a display device to be one of I/O components 112. Also, processors, such as one or more processors 106, have memory. The present disclosure hereof recognizes that such is the nature of the art, and reiterates that FIG. 1 is merely illustrative of an exemplary computing environment that can be used in connection with one or more implementations of the present disclosure. Distinction is not made between such categories as “workstation,” “server,” “laptop,” “handheld device,” etc., as all are contemplated within the scope of FIG. 1 and refer to “computer” or “computing device.”

Computing device 100 typically includes a variety of computer-readable media. Computer-readable media can be any available media that can be accessed by computing device 100 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data. Computer storage media includes RAM, ROM, EEPROM, flash memory or other memory technology, CD-ROM, digital versatile disks (DVD) or other optical disk storage, magnetic cassettes, magnetic tape, magnetic disk storage or other magnetic storage devices. Computer storage media of the computing device 100 may be in the form of a dedicated solid state memory or flash memory, such as a subscriber information module (SIM). Computer storage media does not comprise a propagated data signal.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 104 includes computer-storage media in the form of volatile and/or nonvolatile memory. Memory 104 may be removable, nonremovable, or a combination thereof. Exemplary memory includes solid-state memory, hard drives, optical-disc drives, etc. Computing device 100 includes one or more processors 106 that read data from various entities such as bus 102, memory 104 or I/O components 112. One or more presentation components 108 presents data indications to a person or other device. Exemplary one or more presentation components 108 include a display device, speaker, printing component, vibrating component, etc. I/O ports 110 allow computing device 100 to be logically coupled to other devices including I/O components 112, some of which may be built in computing device 100. Illustrative I/O components 112 include a microphone, joystick, game pad, satellite dish, scanner, printer, wireless device, etc.

The radio 120 represents one or more radios that facilitate communication with one or more wireless networks using one or more wireless links. While a single radio 120 is shown in FIG. 1, it is expressly contemplated that there may be more than one radio 120 coupled to the bus 102. In aspects, the radio 120 utilizes a transmitted to communicate with a wireless telecommunications network. It is expressly contemplated that a computing device 100 with more than one radio 120 could facilitate communication with the wireless network via both the first transmitter and additional transmitters (e.g. a second transmitter). Illustrative wireless telecommunications technologies include CDMA, GPRS, TDMA, GSM, and the like. The radio 120 may carry wireless communication functions or operations using any number of desirable wireless communication protocols, including 802.11 (Wi-Fi), WiMAX, LTE, 3G, 4G, LTE, 5G, NR, 6G, VoLTE, VoNR, or other VoIP communications. As can be appreciated, in various embodiments, radio 120 can be configured to support multiple technologies and/or multiple radios can be utilized to support multiple technologies. A wireless telecommunications network might include an array of devices, which are not shown as to obscure more relevant aspects of the invention. Components such as a base station or communications tower (as well as other components) can provide wireless connectivity in some embodiments.

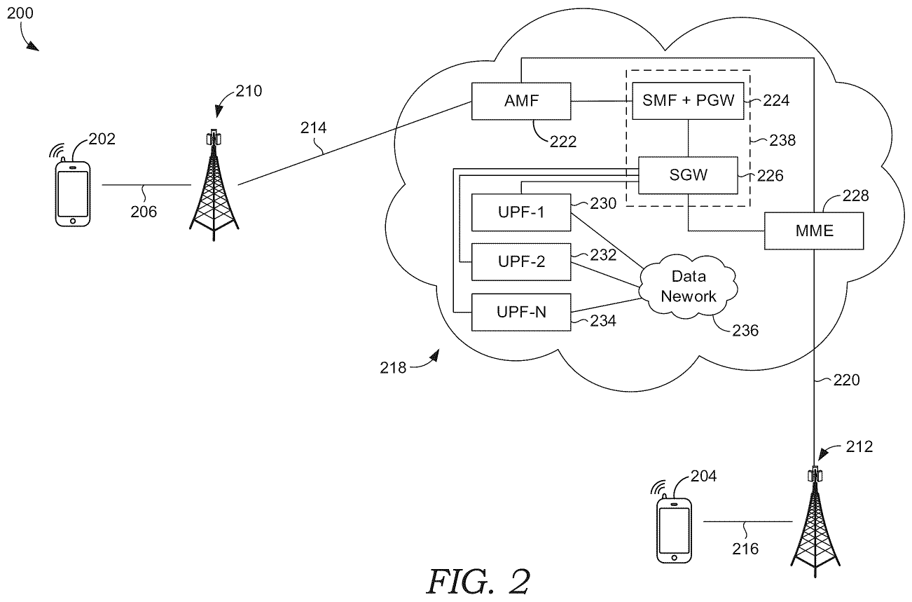

Referring now to FIG. 2, an exemplary network environment is illustrated in which implementations of the present disclosure may be employed. Such a network environment is illustrated and designated generally as network environment 200. Network environment 200 is but one example of a suitable network environment and is not intended to suggest any limitation as to the scope of use or functionality of the invention. Neither should the network environment be interpreted as having any dependency or requirement relating to any one or combination of components illustrated.

Network environment 200 represents a high level and simplified view of relevant portions of a modern wireless telecommunication network. At a high level, the network environment 200 may generally be said to comprise one or more UEs, such as a first UE 202 and/or a second UE 204, one or more base stations, such as a first base station 210 and/or a second base station 212, and a network 218, though in some implementations, it may not be necessary for certain features to be present. The network environment may include a number of routers, switches, and the like. The network environment 200 is generally configured for wirelessly connecting the first UE 202 and/or the second UE 204 to data or services that may be accessible on one or more application servers or other functions, nodes, or servers not pictured in FIG. 2 so as to not obscure the focus on the present disclosure.

The network environment 200 comprises one or more of the first UE 202 and the second UE 204. Though network environment 200 is illustrated with both the first UE 202 and the second UE 204, one skilled in the art will appreciate that fewer or more UEs may be present in any particular network environment. The first UE 202 and the second UE 204 are illustrated generally, and may take any number of forms, including a tablet, phone, or wearable device, or any other device discussed with respect to FIG. 1 and may have any one or more components or features of the computing device 100 of FIG. 1.

The network environment 200 comprises one or more of the first base station 210 and/or the second base station 212 to which the first UE 202 and/or the second UE 204 may potentially connect to. Though network environment 200 is illustrated with both the first base station 210 and the second base station 212, one skilled in the art will appreciate that additional base stations may be present in any particular network environment. Each of the first base station 210 and the second base station 212 of the network environment 200 is configured to wirelessly communicate with UEs, such as the first UE 202 and/or the second UE 204 using any wireless telecommunication protocol desired by a network operator, including but not limited to 3G, 4G, 5G, 6G, 802.11x and the like. The first base station 210 is configured to transmit signals to the first UE 202 and receive signals therefrom using a first wireless connection 206. The second base station 212 is configured to transmit signals to the second UE 204 and receive signals therefrom using a second wireless connection 216. The first base station 210 utilizes a first backhaul connection to communicate with the network 218 and the second base station 212 utilizes a second backhaul connection 220 to communicate with the network 218.

Each of the first base station 210 and the second base station 212 have an internet protocol version that it supports for use with transporting information between UEs and the network 218; for example, the first base station 210 may have dual-stack capability that supports both internet protocol version 4 (IPv4) and internet protocol version 6 (IPv6), whereas the second base station 212 may only support IPv4 or IPv6—but not both. When a base station, such as the first base station 210 or the second base station 212, establishes a connection with the network 218, it sends a setup request message to a mobility network function (e.g., an access and mobility function (AMF) or a mobility management entity (MME)) that typically includes supported tracking areas, a node/cell identifier, and a network identifier (e.g., a public land mobile network (PLMN) identity). In 4G, this message may be known as the S1setuprequest; in 5G, this message may be known as NGSetupRequest. The setup request message may be sent when a node is powered on, after a reset, or any other time that it needs to establish or re-establish a signaling connection with the network 218, such as after updates, after a network fault/outage, or when the node is re-configured to utilize a different mobility network function. In aspects, the setup request message may additionally or alternatively be communicated at a predetermined periodicity (e.g., once every 12 hours, 24 hours, etc.). According to aspects of the present disclosure, the setup request message comprises an IP version compatibility indicator. In a first embodiment, the IP version compatibility indicator may take the form of an information element that indicates whether a particular base station is capable of dual stack IP support (i.e., supports both IPv4 and IPv6) or whether the particular base station does not support dual stack. In a second embodiment, the IP version compatibility indicator may take the form on an information element that affirmatively indicates which IP version the base station supports (e.g., IPv4-only, IPv6-only, or dual-stack). In a third embodiment, the IP version compatibility indicator may take the form of two information elements, wherein a first information element indicates whether the particular base station supports dual stack and wherein a second information element indicates whether the particular base station supports IPv4 or IPv6 (in aspects, the second information element may only be communicated if the first information element indicates that the base station does not support dual stack).

The network environment comprises the network 218, which comprises a plurality of functions and/or components that, together, facilitate the provision of wireless service to the first UE 202 and the second UE 204. As used herein, the term “network function” (NF) is used to describe a computer processing module and/or one or more computer executable services being executed on one or more computing processing modules. For example, the network 218 may comprise NFs that include any one or more of an access and mobility management function (AMF) 222, a session management function (SMF) coupled to a packet gateway (PGW) 224, a serving gateway (SGW) 226, a mobility management entity (MME) 228, one or more user plane functions (UPFs) 230, 232, 234, and a data network 236. Notably, the preceding nomenclature is used with respect to the 3GPP 4G and 5G architecture; in other aspects each of the preceding NFs may take different forms, including consolidated or distributed forms that perform the same general operations. In other architectures or protocols, the NFs may be given other names, however, the NFs herein refer to functions, not specifically identified components. Though the AMF 222, SMF+PGW 224, SGW 226, MME 228, UPFs 230, 232, 234, and the data network 236 are illustrated in the network 218, the network 218 may have more or fewer NFs than shown. Further, though the AMF 222, SMF+PGW 224, SGW 226, MME 228, UPFs 230, 232, 234, and the data network 236 are illustrated as disposed within the network 218 it is expressly contemplated that the location in the network environment 200 is non-limiting. For example, the NFs described above may be disposed between the first base station 210 and/or the second base station 212 and the network 218 (i.e., the network edge) or may be isolated as stand-alone components, or a combination of these.

The network 218 may include NFs as defined by their function. The network 218 comprises one or more mobility network functions such as the AMF 222 or the MME 228. The one or more mobility network functions are generally responsible for managing registration and mobility of UEs, such as the first UE 202 and/or the second UE 204, and achieves this by coordinating signaling between UEs, such as the first UE 202 and/or the second UE 204, and other NFs. The network 218 comprises one or more session management network functions such as the SMF+PGW 224 or the SGW 226. The one or more session management network functions are generally configured to manage the control plane aspects of user data sessions, including the setup, modification, and release of data paths, while ensuring efficient routing and forwarding of user data between the radio access network and the core network, and applying necessary policies like Quality of Service (QoS) and mobility management. Importantly with respect to the present disclosure, the one or more session management NFs are also responsible for selecting a UPF from a plurality of available UPFs, indicated in the illustration of the network 218 as comprising an “N” number of UPFs. Each of the plurality of UPFs are configured to manage the forwarding and routing of user data packets between the radio access network and external data networks, handle packet inspection and policy enforcement, an support traffic and Quality of Service (QoS) enforcement based on the control plane instructions from the one or more session management NFs.

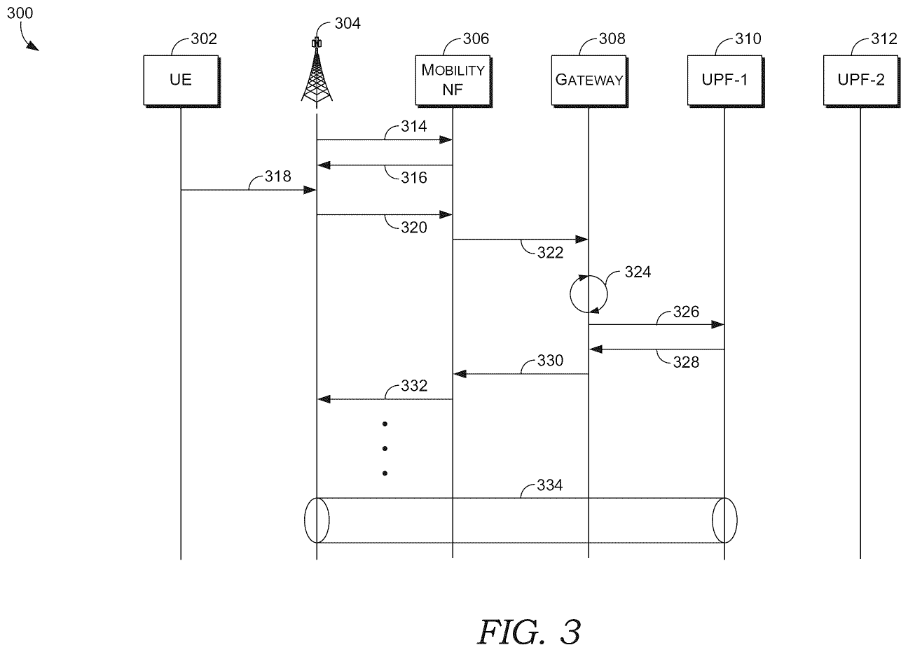

Turning now to FIG. 3, a call flow diagram is illustrated for use by the one or more components illustrated in the network environment 200 of FIG. 2. The call flow 300 is not meant to exhaustively show every interaction that would be necessary to practice the invention, so as not to obscure the present disclosure, but is instead meant to illustrate the one or more potential interactions relevant to the present disclosure. The call flow 300 may be relevantly said to include a UE (such as the first UE 202 or the second UE 204 of FIG. 2), a first base station 304 (e.g., the first base station 210 or the second base station 212 of FIG. 2), a mobility NF 306 (e.g., the AMF 222 or MME 228 of FIG. 2), a gateway 308 (e.g., the session management NF in the form of the SGW 226 or the SMF+PGW 224 of FIG. 2), a first UPF 310 (e.g., UPF1 230 of FIG. 2), and a second UPF 312 (e.g., UPF2 232 of FIG. 2).

The call flow 300 begins with a setup request message begin communicated from the base station 303 to the mobility NF 306 at a first step 314. The setup request message includes one or more information elements that indicate an IP version capability or computability of the base station 304, according to any one or more aspects or embodiments described with respect to FIG. 2. At a second step 316 the mobility NF 306 communicates a setup response message to the base station 304 that indicates the setup request message was successfully received and processed by the mobility NF 306. At a third step 318, the UE 302 communicates one or more messages (e.g., an initial UE message, attach request, PDN connectivity request, PDU session establishment request, or the like) to the base station 304 that is used to trigger the creation of a PDU session. At a fourth step 320, the base station 304 communicates the PDU session creation message to the mobility NF 306. At a fifth step 322, the mobility NF 306 communicates a session request message to the gateway 308; examples of the session request message include Nsmf_PDUSession_CreateSMContext Request in 5G and the Create Session Request message in 4G. The session request message communicated in the fifth step 322 initiates the establishment of a data session for the UE 302 and includes an indication of the IP version capabilities of the base station 304.

At a sixth step 324, the gateway 308 processes the session request message to determine the IP version capabilities of the base station 304 and selects the first UPF 310 from an available plurality of UPFs (comprising at least the second UPF 312) at least partially based on a determination that the first UPF has the same IP version capability as the base station 304. In a first example of the sixth step 324, the gateway 308 may select the first UPF 310 at least partially based on a determination that both the first UPF 310 and the base station 304 do not support dual stack IP versions, whereas the second UPF 312 uses dual stack IP versions. In a second example of the sixth step 324, the gateway 308 may select the first UPF 310 at least partially based on a determination that both the first UPF 310 and the base station 304 support dual stack IP versions, whereas the second UPF 312 supports IPv4 only. In a third example of the sixth step 324, the gateway 308 may select the first UPF 310 at least partially based on a determination that the both the first UPF 310 and the base station 304 support IPv4 only and the second UPF 312 supports IPv6 only. One skilled in the art will appreciate that the additional scenarios consistent with the previous examples are within the bounds of the like-IPversion-based UPF selection procedure.

The call flow 300 continues at a seventh step 326 wherein the gateway 308 communicates a session establishment request message to the first UPF 310. At an eighth step 328, the first UPF 310 communicates a session establishment response message to the gateway 308 comprising transport layer information matching the IP version capabilities of the base station 304 as communicated in the setup request message of the first step 314 and the session request message of the fifth step 322; for example, if the base station 304 supports IPv4 only, then the session establishment response message of the eighth step 328 comprises only an IPv4 address to be assigned to the UE 302 for the session requested by the UE 302. In another example, if the base station 304 supports dual stack, then the session establishment response message of the eighth step 328 comprises both an IPv4 and an IPv6 address to be assigned to the UE 302 for the session requested by the UE 302. At a ninth step 330, the gateway 308 communicates a session establishment accept message that comprises the IP address assignment to the mobility NF 306. At a tenth step 332, the mobility NF 306 communicates a message to the base station 304 that comprises the IP address assignment for the UE 302, wherein the IP version of the IP address assignment matches the IP version capabilities of the base station 304. Subsequent to the tenth step 332, a session user plane is established at step 334.

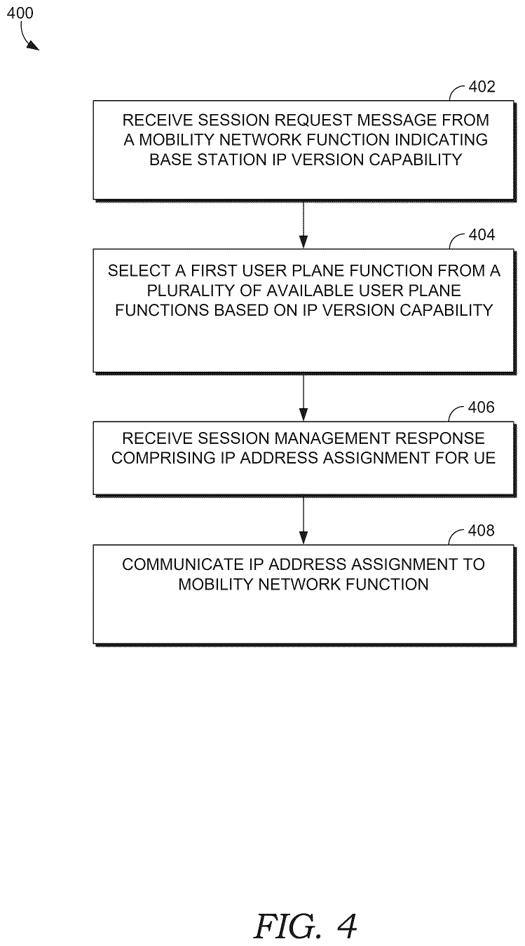

Turning now to FIG. 4, a flow chart is provided that illustrates one or more aspects of the present disclosure relating to a method 400 for selecting a UPF having an IP version capability that matches a base station. In a first step 402, a gateway or session management NF receives a session request message from a mobility NF that indicates an IP version supported by a base station associated with a session requested between a UE and the base station, according to any one or more aspects described with respect to FIGS. 2-3. At a second step 404, the gateway or session management NF selects a first UPF from an available plurality of UPFs, wherein the first UPF is selected at least partially based on an IP version capability of the first UPF matching the IP version capability of the base station, according to any one or more aspects described with respect to FIGS. 2-3. At a third step 406, the gateway of session management NF receives a session establishment response message from the selected first UPF that comprises an IP address assignment for the UE, wherein the IP address assignment has an IP version that matches the IP version capability of the base station, according to any one or more aspects described herein with respect to FIGS. 2-3. At a fourth step 408, the gateway of session management NF communicates the IP address assignment to a mobility NF for use in establishing a session for the UE, according to any one or more aspects described herein with respect to FIGS. 2-3.

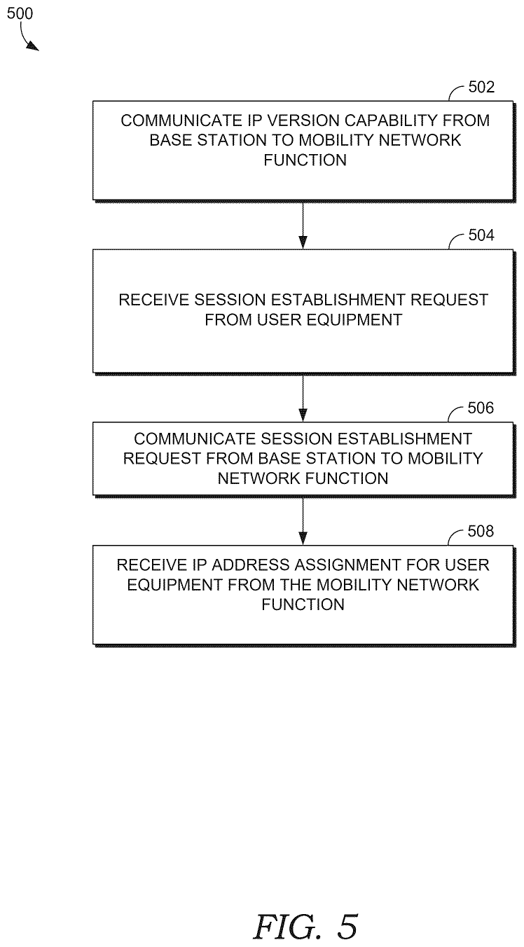

Turning now to FIG. 5, a flow chart is provided that illustrates one or more aspects of the present disclosure relating to a method 500 for establishing a session for a UE by a base station. In a first step 502, the base station communicates a setup request message to a mobility NF that comprises an indication of an IP version capability of the base station, according to any one or more aspects described herein with respect to FIGS. 2-3. At a second step 504, the base station receives a session establishment request message from a UE, according to any one or more aspects described herein with respect to FIGS. 2-3. At a third step 506, the base station communicates a session establishment request to a mobility NF in order to facilitate the establishment of a PDU session for the UE, according to any one or more aspects described herein with respect to FIGS. 2-3. At a fourth step 508, the base station receives a message from the mobility NF that comprises an IP address assignment for the UE for use with the session requested by the UE, wherein the IP address assignment uses a version that matches the IP version capabilities of the base station, according to any one or more aspects described herein with respect to FIGS. 2-3.

Many different arrangements of the various components depicted, as well as components not shown, are possible without departing from the scope of the claims below. Embodiments in this disclosure are described with the intent to be illustrative rather than restrictive. Alternative embodiments will become apparent to readers of this disclosure after and because of reading it. Alternative means of implementing the aforementioned can be completed without departing from the scope of the claims below. Certain features and subcombinations are of utility and may be employed without reference to other features and subcombinations and are contemplated within the scope of the claims.

In the preceding detailed description, reference is made to the accompanying drawings which form a part hereof wherein like numerals designate like parts throughout, and in which is shown, by way of illustration, embodiments that may be practiced. It is to be understood that other embodiments may be utilized and structural or logical changes may be made without departing from the scope of the present disclosure. Therefore, the preceding detailed description is not to be taken in the limiting sense, and the scope of embodiments is defined by the appended claims and their equivalents.

What is claimed is:

1. A system for selecting a user plane function (UPF) based on internet protocol (IP) version capability, the system comprising:
one or more computer processing components configured to execute operations comprising:
receiving a session establishment request message from a mobility network function (NF), wherein the request message is associated with a session between a radio access network (RAN) node and a UE, the request message comprising one or more information elements that indicate the RAN node has a first internet protocol stack capability; and
selecting a first user plane function (UPF) from a plurality of available UPFs at least partially based on the first UPF having the first internet protocol stack capability.

2. The system of claim 1, wherein the mobility NF is an access and mobility management function (AMF).

3. The system of claim 2, wherein the one or more computer processing components comprises a session management function.

4. The system of claim 1, wherein the mobility NF is a mobility management entity (MME).

5. The system of claim 4, wherein the one or more computer processing components is a serving gateway (SGW).

6. The system of claim 1, wherein the first internet protocol stack capability is internet protocol version 4 (IPv4) only and wherein at least one of the plurality of available user plane functions is configured to use both IPv4 and internet protocol version 6 (IPv6).

7. The system of claim 1, wherein the first internet protocol stack capability is internet protocol version 4 and internet protocol version 6 and wherein at least one of the plurality of available user plane functions is configured to use internet protocol version 4 only.

8. A method for selecting a user plane function (UPF) based on internet protocol (IP) version capabilities, the method comprising:
receiving a session establishment request message from a mobility network function (NF), wherein the request message is associated with a session between a radio access network (RAN) node and a user equipment (UE), the request message comprising one or more information elements that indicate the RAN node has a first internet protocol version; and
selecting a first user plane function (UPF) from a plurality of available UPFs at least partially based on the first UPF having the first IP version capability.

9. The method of claim 8, further comprising receiving a session management response message from the first UPF comprising an IP address assignment for the UE.

10. The method of claim 9, further comprising communicating the IP address assignment to the mobility NF.

11. The method of claim 10, wherein the mobility NF is an access and mobility management function (AMF).

12. The method of claim 11, wherein the one or more computer processing components comprises a session management function.

13. The method of claim 10, wherein the mobility NF is a mobility management entity (MME).

14. The method of claim 13, wherein the one or more computer processing components is a serving gateway (SGW).

15. The method of claim 10, wherein the first internet protocol stack capability is internet protocol version 4 (IPv4) only and wherein at least one of the plurality of available user plane functions is configured to use both IPv4 and internet protocol version 6 (IPv6).

16. The method of claim 10, wherein the first internet protocol stack capability is internet protocol version 4 and internet protocol version 6 and wherein at least one of the plurality of available user plane functions is configured to use internet protocol version 4 only.

17. A method for selecting a core network function based on internet protocol (IP) version capabilities of a base station, the method comprising:
communicating a message from the base station to a mobility network function of a telecommunication network, the message comprising an IP version capability of the base station;
receiving a session establishment request from a user equipment (UE);
communicating the session establishment request to the mobility network function; and
receiving an IP address assignment for the UE from the mobility network function, the IP address assignment having an IP version being the same as the IP version capability of the base station.

18. The method of claim 17, wherein the message is periodically communicated from the base station to the mobility network function.

19. The method of claim 17, wherein the IP version capability indicates the base station does not support dual stack IP assignments.

20. The method of claim 17, wherein the IP version capability is selected from a group consisting of IP version 4 (IPv4) only, IP version 6 (IPv6) only, and dual stack IP versions.
